(19) United States
(12) Patent Application Publication
(10) Pub. No.: US 2011/0029454 A1
(43) Pub. Date: Feb. 3, 2011

(54) LINEAR PROGRAMMING USING L1 MINIMIZATION TO DETERMINE SECURITIES IN A PORTFOLIO

(76) Inventors: Rajan Lukose, Oakland, CA (US); Martin B. Scholz, San Francisco, CA (US); Shyam S. Rajaram, Mountain View, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/533,864

(22) Filed: Jul. 31, 2009

(51) Int. Cl. G06Q 40/00

(52) U.S. Cl. 705/36 R

(57) ABSTRACT

A computer-implemented method comprises receiving, by a processor, a vector and a matrix. The vector includes historical periodic returns of a portfolio and the matrix contains historical periodic returns of each security in a set of all possible securities comprising the portfolio. The method further comprises computing, by a processor, a linear programming solution of a vector of weights of the securities comprising the portfolio. The vector comprises a product of the matrix and the vector of weights. The linear programming solution is subject to a criterion that a sum of absolute values of the weights in the vector of weights is a minimum. The method also comprises displaying or storing results of the computing.

### BACKGROUND

Financial management, brokering, and trading are highly competitive businesses in which information is highly important. Participants often wish to hide their current positions (which include holdings of financial instruments such as stocks, bonds, etc.) from their competitors. However, competitors may desire to know which financial instruments, and in what proportion, are in a given portfolio.

### BRIEF DESCRIPTION OF THE DRAWINGS

For a detailed description of illustrative embodiments of the invention, reference will now be made to the accompanying drawings in which:

FIG. 1 shows an example system in accordance with various embodiments;

FIG. 2 shows an example method in accordance with various embodiments; and

FIG. 3 shows an example method of determining the number of days of historical data to use in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either a logical, physical, indirect, direct, optical or wireless electrical connection. Thus, if, for example, a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

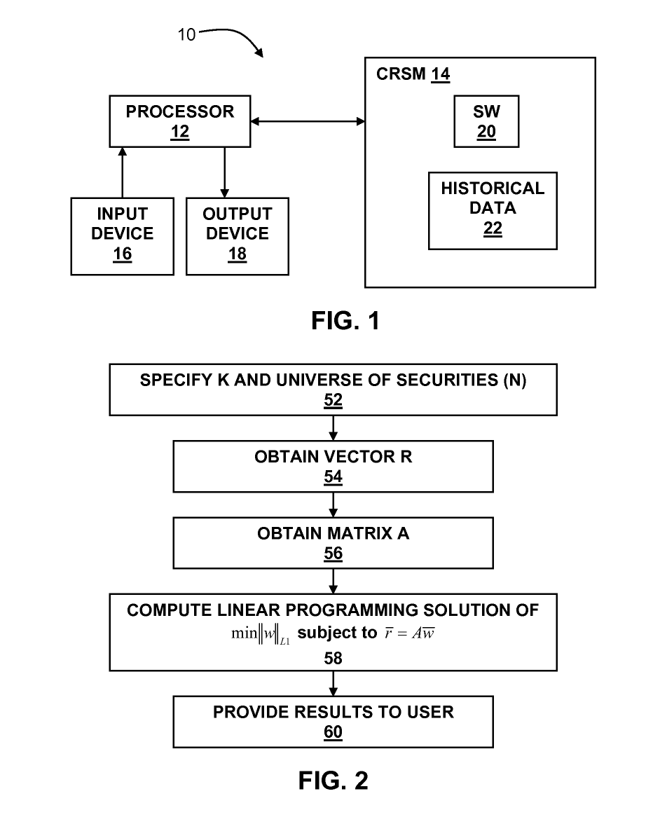

FIG. 1 shows an example system 10 in accordance with various illustrative embodiments. In some embodiments, the system is a computer such as a computer (e.g., server, desktop, notebook, handheld, etc.). The system 10 comprises one or more processors 12 coupled to a computer-readable storage medium (CRSM) 14, an input device 16, and an output device 18. The input device 16 may comprise any one or more of a keyboard, mouse, trackball, touchpad, etc. The output device 18 may comprise a display or a printer or other form of output device.

The CRSM 14 comprises volatile memory (e.g., random access memory), non-volatile storage (e.g., hard disk drive, Flash storage, compact disc read only memory, etc.), or combinations thereof. The CRSM 14 contains software 20 that is executed by the processor 12. The software 20 provides the processor 12, and thus system 10, with some or all of the functionality described herein. In some embodiments, a single processor performs all of the functionality described herein. In other embodiments, the software executes on a multi-processor system in which one processor may perform one or more of the steps described herein and one or more other processors execute one or more other steps.

A portfolio contains one or more securities that comprise the portfolio. A security is a fungible, negotiable instrument representing financial value. Each security can be a stock, a bond or a financial instrument of any kind. In accordance with various embodiments, the constituent securities of the portfolio may be all of the same type (e.g., all stocks) or may be a mix of different security types (some stock, some bonds, etc.). The term “portfolio” broadly refers to any kind of aggregation of securities. An example of a portfolio is a fund such as a mutual fund. However, the term portfolio can refer to aggregations of securities besides a fund.

The technique disclosed herein determines the securities that make up a target portfolio. The technique uses historical data. CRSM 14 in FIG. 1 contains historical data 22 which can be generated by the software 20 or otherwise obtained by the software 20 from a source such as an external network or database. The historical data comprises a number of days of periodic (e.g., daily) returns of the portfolio. A daily return refers to the percentage increase or decrease in the portfolio's net asset value from one day to the next. The number of days of historical data is referred to as “K.” K may be, for example, 10. As such, 10 days of historical daily returns of the portfolio are used in the computations.

The historical data also comprises the daily returns, over the same K days, of the universe of possible securities that might make up the portfolio. For example, if it is at least known that the constituent securities in the portfolio are stocks within the S&P 500, then the historical data comprises the daily returns over the K days of the all 500 stocks that make up the S&P 500 index. It is not known which or how many of the S&P 500 stocks are in the portfolio in question; the software 20 computes a solution to a particular linear program to make that determination as described below. Each such daily return reflects the percentage increase or decrease of each individual security.

Using the historical data of the daily returns of the portfolio in question as well as the daily returns of the universe of possible securities that could make up the portfolio in question, the software 20 computes the linear programming solution of:

min∥w∥_{L1} subject to r̅=A w̅. (1)

The quantity r is a vector containing the historical daily returns of the value of the portfolio. A is a matrix containing the historical daily returns of each security in a set of all possible securities in said portfolio. “L1” indicates L1 minimization, and is sometimes written as L₁. The process computes the vector w which comprise weights, one weight value for each possible security in the portfolio. The solution of min∥w∥_{L1} includes the securities determined to be in the portfolio. There may be, and likely are, multiple w vectors that solve the equation r̅=A w̅. For L1 minimization, the software 20 determines the one vector w (of all possible w vectors that solve the equation r̅=A w̅) with minimal L1 norm which means that the sum of the absolute values of the elements of w is a minimum. That is, for all possible w vectors, the vector for which the sum of absolute values of its elements is the smallest is the vector chosen for the portfolio.

Each element of w corresponds to one of the securities provided in matrix A. For example, in the case of the S&P 500 index, the matrix A contains historical data for all 500 stocks in the index. The w vector that solves the linear program above contains 500 values; one value for each stock. Each element in the vector w is a weight value that indicates what fraction of the portfolio each security represents. In at least some embodiments, vector w is normalized to 1 which means its weight value in vector w is a value ranging from 0 to 1 inclusive. The chosen/computed vector w that solves equation (1) above contains some zero values and some non-zero values. A zero value means that the corresponding security is not in the portfolio in question. A non-zero value means that the corresponding security is in the portfolio in question and how much (e.g., expressed as a fraction in at least some embodiments) of the portfolio rests with that particular security.

The linear program subject to the L1 minimization works when relatively few of the universe of securities are actually in the portfolio thereby resulting in relatively few non-zero values in the vector w (which specifies how much of each possible security is in the portfolio in question). A w vector with relatively few non-zero values is said to be “sparse.” Accordingly, the L1 minimization technique described herein works because the resulting w vector is sparse.

Further, the linear program provided above works with relatively few days of historical data compared to the number of securities represented in matrix A of historical data. If there are N securities represented in matrix A, then the above linear program works when K<<N.

Thus, the two conditions of interest are:

(a) w is sparse (i.e., contains relatively few nonzero entries elative to N) (b) K<<N.

Condition (a) expresses the fact that the portfolio is actively managed with relatively few holdings. If the portfolio has many holdings relative to the universe of possible securities that could be included in the portfolio, then an exact reconstruction may not be obtained although an adequate approximation is possible.

Condition (b) expresses the fact that it is desirable to determine the constituent elements of a portfolio with as little historical data as possible. Many portfolios are actively managed and thus frequently buy and sell securities. That being the case, requiring, say, a year's worth of historical data is of questionable value in analyzing a portfolio that will have sold off at least some of the securities it held a year ago. Being able to determine a portfolio's holdings using only the most recent data (e.g., 100 days worth of data) is beneficial as such data is likely to more relevant than data that is much older.

In some cases, there may be some measurement noise. Measurement noise may comprise a miss-estimation of the universe of potential securities (i.e. the columns of A). It may also comprise mild inaccuracies in the returns reported in the vector r or the matrix A. In such cases a more error tolerant optimization problem can be set up that will closely approximate the basic setup when errors are not too significant. At least two possibilities are available in such embodiments. In one embodiment, the linear programming solution of the following expression is solved: min∥\vec{w}∥_{L1} subject to ∥\vec{r}−A\vec{w}∥_{L2}≦ε. A tolerance ε of error is chosen that one is willing to accept (measured according to the L2 norm), and the L1 norm of \vec{w} is minimized consistent with that tolerance. In accordance with another embodiment, the linear programming solution of

$${min}_{\vec{w}} {‖ \vec{r} - A \vec{w} ‖}_{L 1}$$

s solved. The \vec{w} vector is determined that minimizes the L1 norm of the difference between the two vectors in the argument, which is the estimated error, and which is known. Both of these approaches are robust and error tolerant in the sense that they do not require that \vec{r}=A\vec{w}.

FIG. 2 illustrates an example method embodiment, which is executable, for example, on system 10. The steps shown in FIG. 2 can be performed in the order shown, or in a different order. Further, two or more of the steps may be performed concurrently rather than serially. As shown at 52, the method comprises specifying the value K and the universe of securities that conceivably comprise the portfolio in question. The value K and the universe of securities may be specified by a user via a graphical user interface implemented by software 20. The universe of such securities has N securities. The user may specify a known designation for the universe of securities that might make up the portfolio in question such as “S&P 500.” In other embodiments, the user enters the name or other designation for each security that the user believes may comprise the portfolio in question.

At 54, the method comprises obtaining vector r. Obtaining the vector r may comprise retrieving the vector from memory such as CRSM 14 or from a site across a network. Further, obtaining the vector r may comprise computing the daily returns for the portfolio based on the daily closing price (e.g., net asset value, NAV) for the portfolio over the specified time period K.

At 56, the method comprises obtaining matrix A. Obtaining the matrix A may comprise retrieving the matrix from memory such as CRSM 14 or from a site across a network. Further, obtaining the matrix A may comprise computing the daily returns for the universe of securities possibly forming the portfolio in question based on the daily closing prices (e.g., net asset value, NAV) for such securities over the specified time period K.

At 58, the method comprises computing the linear programming solution of min∥w∥_{L1} subject to r̅=A w̅ to determine the securities comprising the portfolio in question. The computed results can be provided to a user of the software at 60. Providing the results comprises providing the results to output device 18 which may be comprise a display or a printer as noted above. If desired, the non-zero values may be eliminated from resulting vector w so that the user is provided with only the identities of those securities that are determined to be in the portfolio in question.

The value K (number of days of historical data used in the calculations) can be determined in accordance with any of a variety of techniques. For instance, a user could determine and specify K by trial and error on what is generally known about the portfolio to be reconstructed, and empirically determine K through simulation what the correct minimum K needs to be.

The value K can be determined another way. Each row of the A matrix is a day's worth of new data. At the end of every day, a user adds on a new row of historical data to matrix A, the L1 minimization technique described above is performed to compute a new w vector. So as each day passes, the matrix A grows by a row and K increments by 1 as well, and a new w vector is determined. At some point, the matrix A will have enough rows (K) of data that the w vector will stop changing from day to day. Accordingly, a threshold can be specified by a user for how much ∥w(t+1)−w(t)∥_L2 should be. Then that threshold could be a “stopping criterion” for determining when K is large enough. The “L2” notation represents the magnitude of Euclidean distance between the 2 vectors w(t+1) and w(t).

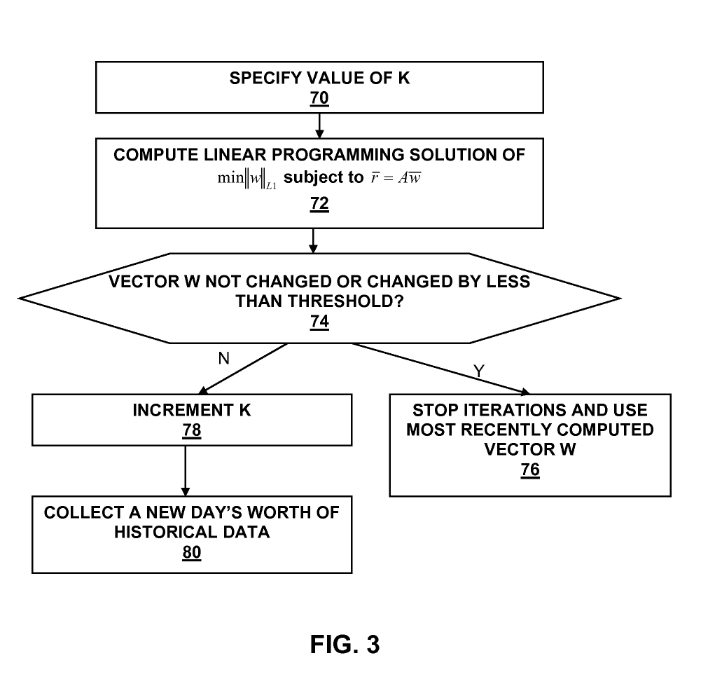

The immediately preceding process for determining the value K is further illustrated in FIG. 3. The initial value K is specified (e.g., by a user or pre-programmed) at 70. The linear program solution min∥w∥_{L1} subject to r̅=A w̅ is solved at 72 to obtain the weight vector w, as explained previously. At 74, the process determines whether the resulting vector w is does not change or changes by less than a threshold amount from the previous vector w (which uses less historical data) then the iterative process stops at 76 and the most recently calculated vector w is used in determining the constituent securities in the portfolio. An example of a threshold is provided above. If, however, the most recently computed vector w changes by more than the threshold, then at 78 the value K is incremented and at 80 an additional day's worth of historical data is collected and added to the matrix A and vector r. The process loops back to 72 and repeats. The process repeats with each iteration using an incremented value K and additional historical data until the vector w does not change or changes by less than the threshold amount.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A computer-implemented method, comprising:
receiving, by a processor, a vector and a matrix, wherein said vector includes historical periodic returns of a portfolio and said matrix contains historical periodic returns of each security in a set of all possible securities comprising said portfolio; and
computing, by said processor, a linear programming solution of a vector of weights of said securities comprising said portfolio, wherein said vector comprises a product of said matrix and said vector of weights, and wherein said linear programming solution is subject to a criterion that a sum of absolute values of said weights in said vector of weights is a minimum; and
displaying or storing results of said computing.

2. The method of claim 1 wherein said minimum comprises said sum being less than all other sums of absolute values of weights that are linear programming solutions of said vector.

3. The method of claim 1 wherein each weight corresponds to each security in the portfolio and comprises a fraction that said corresponding security is of said portfolio.

4. The method of claim 1 wherein each security comprises a fungible, negotiable instrument representing financial value.

5. The method of claim 1 further comprising receiving a user-specified value of a number of days, and wherein receiving said vector comprises receiving said historical periodic returns of said value of said portfolio over said user-specified number of days and receiving said matrix comprises receiving said historical periodic returns of each security in said set over said user-specified number of days.

6. The method of claim 5 further comprising iterating said computing with an increasing number of days in each iteration until said solution of said linear programming solution ceases to increase by more than a threshold value.

7. The method of claim 6 further comprising displaying or storing said linear programming solution computed using said number of days of said iteration in which said linear programming solution ceases to increase by more than said threshold value.

8. The method of claim 1 further comprising repeating said computing on successive days until the computed linear programming solution changes by less than a threshold amount.

9. A computer-readable storage medium (CRSM) containing software that, when executed by a processor, causes said processor to:
receive a vector and a matrix, wherein said vector includes historical periodic returns of a portfolio and said matrix contains historical periodic returns of each security in a set of all possible securities comprising said portfolio; and
compute a linear programming solution of a vector of weights of said securities comprising said portfolio, wherein said vector comprises a product of said matrix and said vector of weights, and wherein said linear programming solution is subject to a criterion that a sum of absolute values of said weights in said vector of weights is a minimum; and
provide results of said computation of said linear programming solution.

10. The CRSM of claim 9 wherein said software further causes said processor to receive input that specifies a number of days.

11. The CRSM of claim 10 wherein said software causing said processor to receive said vector comprises said processor receiving historical periodic returns of said value of said portfolio over said number of days.

12. The CRSM of claim 10 wherein said software causing said processor to receive said matrix comprises said processor receiving historical periodic returns of each security over said number of days.

13. The CRSM of claim 10 wherein said software further causes said processor to iteratively compute said linear programming solution with an increasing number of days in each iteration until said linear programming solution ceases to increase by more than a threshold value.

14. The CRSM of claim 12 wherein said software causing said processor to provide said results comprises said software causing said processor to provide said results computed using said number of days of said iteration in which said linear programming solution ceases to increase by more than said threshold value.

15. The CRSM of claim 9 wherein each security comprises a fungible, negotiable instrument representing financial value.

16. A computer, comprising:
storage containing software;
a processor coupled to said storage and executes said software, and when executing said software said processor receives a vector and a matrix, wherein said vector includes historical periodic returns of a portfolio and said matrix contains historical periodic returns of each security in a set of all possible securities comprising said portfolio, said processor further computes a linear programming solution of a vector of weights of said securities comprising said portfolio, wherein said vector of historical daily returns is a function of a product of said matrix and said vector of weights, and wherein said linear programming solution is subject to a criterion that a sum of absolute values of said weights in said vector of weights is a minimum, and said processor provides results of said computation of said linear programming solution.

17. The computer of claim 16 wherein said software causes said processor to receive a number of days.

18. The computer of claim 17 wherein said software causing said processor to receive said vector and said matrix comprises said processor to receive said historical periodic returns of said value of said portfolio and to receive said historical periodic returns of each security over said number of days.

19. The computer of claim 18 wherein said software causes said processor to iterate said computation of said linear programming solution with an increasing number of days in each iteration until said solution of said linear programming solution ceases to increase by more than a threshold value.

20. The computer of claim 19 wherein said vector of historical daily returns is a function of a product of said matrix and said vector of weights and an error value.
